(19) United States
(12) Patent Application Publication
(10) Pub. No.: US 2010/0235505 A1
(43) Pub. Date: Sep. 16, 2010

(54) SYNDICATED PRESENCE AND ACTIVITY FEED FEDERATED VIA EXTENDED INTEROPERABLE FORMAT

(75) Inventors: Amit Gupta, Redmond, WA (US); Alexander M. Hehmeyer, Bellevue, WA (US); Rajesh Ramanathan, Redmond, WA (US); Avronil Bhattacharjee, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/400,821

(22) Filed: Mar. 10, 2009

(51) Int. Cl. G06F 15/173; G06F 15/16

(52) U.S. Cl. 709/225; 709/246

(57) ABSTRACT

Architecture for extending a presence document into additional formats and protocols. An aggregator federates the presence document into a standardized schema that can be consumed at a standardized endpoint. The standardized schema can be a web feed that is interoperably consumed by a web feed consumer, for example, an RSS/Atom schema. Access of the presence document content is controlled based on a relationship between the user and a subscriber. Categories are specified for the presence document content, and access is controlled according to the categories. The specified categories can correspond to user authentication levels. The categories can include multiple syndicated channels corresponding to multiple subscriber access levels. In this way, levels of access are defined for various categories of availability information and activity information, based on the relationship of the user to the subscriber.

### BACKGROUND

Presence information is used in communications applications to convey an availability status of a particular user for communicating with other users. For example, presence information is used with instant messaging (IM) applications to indicate whether the user is online and running an active IM connection. Availability status can be indicated by an icon that appears to a watching user. For example, the icon can display a green “jellybean” to indicate availability, and can present a pink “jellybean” to indicate offline status.

With social media, the user may convey an activity status, for example, to indicate the activity in which the user is currently engaged. One online social application includes an update status field that enables the user to enter a response to a question, “What are you doing right now?” A status response entered by the user is viewable by all the members of the user's social network, who can optionally comment on the user's status. Another online social application enables the user to enter status messages that are viewed by the user's followers, and enables the user to follow other users to view their status messages.

Presence information can be employed as a channel to which a subscriber (a “watcher”) can subscribe to obtain availability and context information for a particular “publisher”. In a network-based application, presence information is obtained by subscribers over the network via endpoints operating under compatible protocols. However, there can be difficulties for communications among users operating under incompatible protocols.

Off-site collaborators using incompatible communications software cannot obtain presence information for each other. For example, such difficulties can arise between sales personnel and customers operating different communications applications. In these situations and others, an inability to exchange presence information can create delays and miscommunications, which can result in inefficiency, wasted time and effort, and reduced productivity.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

To that end, architecture is disclosed for enabling a publisher to provide extended presence information to watchers and federating the extended presence information to watchers at standardized, interoperable endpoints. The extended presence information can include availability information and activity information, such as information provided from social media and other applications (e.g., enterprise).

The availability information can include a user time availability data and a user location availability data, for example, a particular time and place upon which a user can be contacted. The availability information can also include user contact information, such as an updated cell phone number or a phone number of an organization where the user can be reached, for example.

The activity information can include a status update similar to information posted through various social media and enterprise applications that pertains to a user activity. The activity information can include a current user project upon which the user is working, and related project information, such as a project summary, deadlines, project manager, and team collaborators, for example.

The availability information and activity information for the user is incorporated as presence information into a presence document. Any other user information can additionally be incorporated as presence information into the presence document. This presence information is published by mapping the presence document into a standardized, interoperable syndicated schema, such as syndicated formats of an extended RSS (really simple syndication), RSS 2.0, Atom (an XML language employed in web feeds), and HTTP or any other suitable format or protocol.

The standardized schema is federated to a standardized endpoint, for example, an RSS/Atom aggregator. However, it is to be appreciated that the publication protocol and presence document can also be presented in any suitable format, and can include multiple protocols and document formats. In this way, the presence information is consumed into applications beyond the network endpoints, such as in a web browser or in another suitable application. Thus, providing additional protocols and presence document formats increases the number of applications able to read and interpret the presence information.

The presence document can be accessed by a watcher on the same network, running the same communications application. The watcher can either access the original presence document, or can view the extended, standardized presence document, which is compatible with the same network communications application. In another aspect, a standardized endpoint can use the standardized protocol (e.g., RSS) to publish user information back into the presence document, to become aggregated and distributed to the watchers.

The presence document contents (e.g., the availability information and the activity information) can be selectively controlled based on a relationship between the publisher and the watcher. Categories can be specified for the presence document contents, and access to various presence information items can be controlled according to the categories. For example, category instances can be specified corresponding to user authentication levels. In this way, security can be established to enable watchers to access particular information according to predefined relationships, for example, an internal hierarchy within an organization. The categories can include multiple RSS channels that correspond to respective multiple subscriber access levels. Access to a particular RSS channel is determined based on the user/subscriber relationship.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a computer-implemented system for performing communications.

FIG. 2 illustrates aspects of a schema component as used with the computer-implemented system for performing communications.

FIG. 3 illustrates an access control component for controlling access of availability information and activity information in a presence document.

FIG. 4 illustrates additional aspects of the availability information and the activity information included in the presence document.

FIG. 5 illustrates an alternative embodiment of the computer-implemented system for performing communications.

FIG. 6 illustrates additional aspects of a presence component.

FIG. 7 illustrates an implementation for aggregating and mapping presence information.

FIG. 8 illustrates a method of communications.

FIG. 9 illustrates further aspects in the method of communications.

FIG. 10 illustrates additional aspects in the method of communications.

FIG. 11 illustrates a block diagram of a computing system operable to execute the communications in accordance with the disclosed architecture.

FIG. 12 illustrates an exemplary computing environment operable to provide communications.

### DETAILED DESCRIPTION

The disclosed communications architecture extends presence information in a presence documents into additional formats and protocols. An aggregator federates the presence document into a standardized schema that can be consumed at a standardized endpoint. The standardized schema can be a web feed that is interoperably consumed by a web feed consumer. The standardized schema can be an RSS/Atom schema, for example. The presence document can be federated to both standardized endpoints and endpoints operating with a default internal schema. Moreover, access to the presence document content is controlled based on a relationship between the user and a subscriber.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof The intention is to cover all modifications, equivalents, and alternatives falling within the spirit and scope of the claimed subject matter.

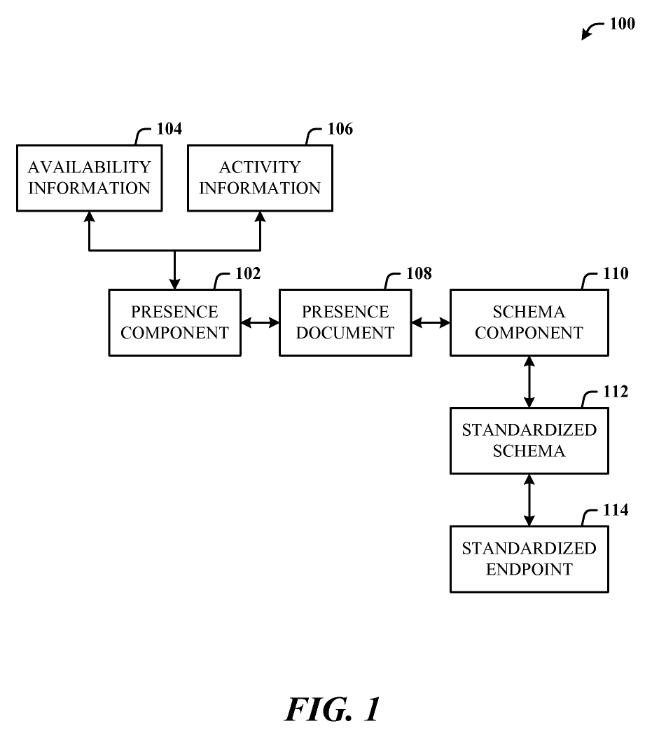

FIG. 1 illustrates a computer-implemented system 100 for performing communications. The system 100 enables a user to indicate presence status in a manner than can be available to a subscriber (also referred to as a “watcher”) operating on a different network or running a different communications application. The system 100 includes a presence component 102 for incorporating user information including availability information 104 and activity information 106 of the user into a presence document 108. The contents of the presence document 108 can be presented to a subscriber as a channel for realtime information regarding the user's status and activities. The presence document 108 can be created for access by default internal endpoints operating with an internal schema (e.g., SIP Rich Presence).

As further illustrated in FIG. 1, the system 100 includes a schema component 110 for mapping the presence document 108 into a standardized schema 112 operable with endpoint clients outside the enterprise network. The schema component 110 federates the schema 112 to a standardized endpoint 114 based on the schema 112, where the standardized endpoint 114 can reside outside the enterprise network. In this way, the availability information 104 and the activity information 106 is federated across applications, enabling a rich spectrum of presence information to be extended to different applications and endpoints beyond network endpoints running communications application that interprets one of the existing presence document formats published by the user. Presence is thus made a channel for sharing a generic activity feed between a publisher and subscribers.

Generally, the standardized schema 112 illustrated in FIG. 1 can include a mapping of the presence document 108 to a web feed, and the standardized endpoint 114 can be a web feed consumer. The web feed consumer consumes the presence document 108 in a standardized syndicated language. It is to be appreciated that any suitable web feed can be employed for any suitable syndicated language. The web feed consumer can be a web browser or any other suitable type of standardized endpoint for consuming a web feed.

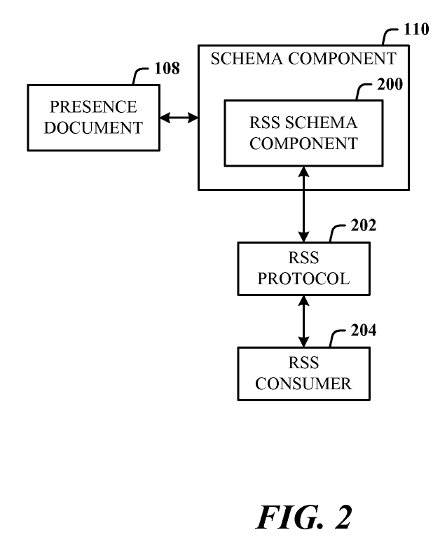

FIG. 2 illustrates aspects of the schema component 110 as employed with the computer-implemented system 100 for performing communications. Specifically, the schema component 110 can include an RSS schema component 200 for extending the presence document 108 according to an RSS protocol 202. The schema component 110 can also map the presence document 108 to an Atom format. In this manner, subscribers can obtain presence information of the publisher by consuming a standard RSS/Atom feed, for example, which can be accomplished using an RSS consumer 204, which can be a web browser or a dedicated RSS reader application. The schema component 110 can also map the presence document 108 into HTTP (hypertext transfer protocol) for use on the Internet. However, it is to be appreciated that the schema component 110 is not limited to the aforementioned formats, and can be used with any suitable format for extension into any other protocol.

Extending the presence document 108 to support a standardized format such as RSS/Atom increases the outreach and accessibility of presence information to subscriber clients that simply support RSS reading and use a type of identity for authentication. By this extension of presence information and interoperability with formats such as RSS, presence status becomes accessible to subscribers on different networks and/or running different communications applications, such as third party applications or enterprise applications.

Publishers can use standardized schema as a social channel for publishing presence information with access control based to an associated social network. The presence information can be federated as a news feed and enabled to be published publicly on social media services. A standardized RSS format can enable presence information to be incorporated into a presence status webpage. Depending on the nature of the presence information, an internal organizational website can include webpages showing the current status of each member of the organization, for example. In the event that status has not been updated for a period of time, the website can prompt the member users for an update by sending an email or a pop-up alert. Construction of such webpages is possible because a common interface can be used for consuming RSS feeds. Thus, presence information is made available in a way that is more extensible for subscribers.

In another aspect, the RSS schema component 200 can use the RSS protocol 202 to publish user information back into the presence document 108 to be aggregated and distributed to other watchers. The information can then be extended back from RSS into a default internal schema (e.g., SIP Rich Presence), to assure interoperability. In another aspect, a user operating remotely from an RSS consumer 204 can access the presence document 108 and publish user information directly into the default internal system.

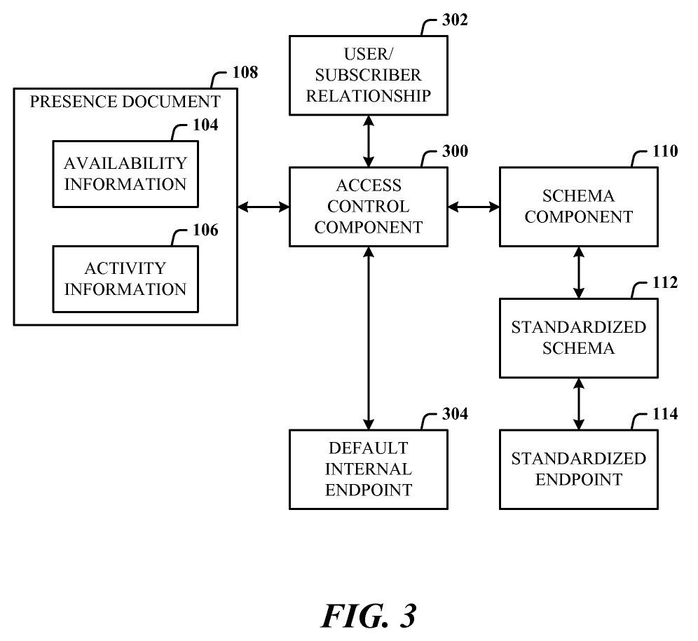

FIG. 3 illustrates an access control component 300 for controlling access of availability information 104 and activity information 106 in a presence document 108. The access control component 300 controls access to the availability information 104 and the activity information 106 based on a user/subscriber relationship 302 (e.g., a publisher-watcher relationship). For a presence document 108 converted into an RSS schema, the access control component 300 can be a server component that performs authentication so that different presence information feeds can be generated for different subscribers having different access levels.

Subscriber access level feeds can provide greater or lesser levels of status information depending on whether the subscriber is a personal friend or family member of the publisher, or in a professional setting, whether the subscriber is a supervisor or subordinate of the user, for example. Access through RSS can be provided on a server that so feeds can be different for different users. In this way, security levels can be established for user presence in accordance with the user/subscriber relationship 302. When presence information is requested, a standard output is provided and all authentication can be performed on the server. Upon receiving a watcher request of an RSS feed, the watcher's credentials can be passed in SOAP (simple object access protocol) request/HTTP header to a presence server, which provides the appropriate RSS feed for that access level. By employing authentication through RSS channels, specific permissioning is not required because websites are already protected by administrators. In a corporate website, the creation of RSS channels enables publication of presence information for each member's company level.

As further illustrated in FIG. 3, the presence document 108 can be federated to both standardized and default internal endpoints. As mentioned hereinabove, the presence document 108 can be converted by the schema component 110 in to a web feed such as RSS protocol or another standardized schema, and federated to the standardized endpoint 114, such as a web browser. The presence document 108 can alternatively be federated to a default internal endpoint 304, such as a compliant proprietary communications application used on the same network as the user. The presence document 108 can be unmodified and federated directly to the default internal endpoint 304 from the access control component 300. A converted version of the presence document 108 can alternatively be federated to the default internal endpoint 304 from the schema component 110, if the converted presence document 108 is in a generic format readable by the endpoint 304.

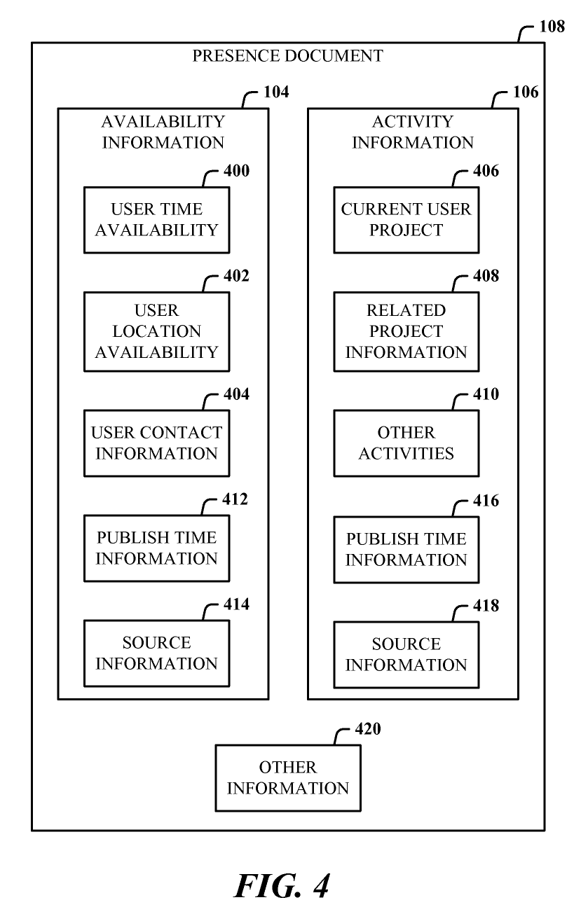

FIG. 4 illustrates additional aspects of the availability information 104 and the activity information 106 included in the presence document 108. The availability information 104 can include information related to the user's availability. The availability information 104 can include user time availability 400, such as currently, in the near future, or in the distant future. Multiple time values and ranges of times can also be indicated with the user time availability 400. User time availability 400 can also include a rating scale of how busy the user is at that moment. The availability information 104 can also include user location availability 402, which can include the user's current location or a location where the user expects to be for a particular time. The availability information 104 can also include user contact information 404, for example, an updated cell phone number or a phone number of an organization or individual where the user can be reached during a particular time and location.

As illustrated in FIG. 4, the activity information 106 can include a listing of a current user project 406 on which the user is working, or whether the user is in a meeting or on a phone call, for example. Related project information 408 can also be included, which can comprise a project summary, detailed description of the project, deadlines, project manager, team collaborators, vendors and suppliers, customers, and related documents and files, for example. The activity information 106 can also include other activities 410, business or personal, including status update information similar to information posted through various social media and enterprise applications that pertains to a user activity. The other activities 410 can receive a stream of status information feeds from social media applications along with related timestamp information, and federate those feeds into the user's presence document 108.

As illustrated in FIG. 4, the presence document 108 also includes publish time information 412 and source information 414 for the availability information 104 and publish time information 416 and source information 418 for the activity information 106. The publishing time information 412, 416 can include the time of each update, to indicate how recent (the “freshness”) the information is. The source information 414, 418 can indicate the application or service that feeds the particular information items.

The publish time information 412 and source information 414 for each item pertains to availability, or as a summary for all availability information 104. The publish time information 416 and source information 418 for each item pertains to activity, or as a summary for all activity information 106. The presence document 108 can alternatively include a summary of publishing time and source information for all information items included therein.

Other information 420 can also be provided in the presence document 108. The other information 420 can include user environment, phone numbers or other contact information, calendar information, and capabilities information of the user. The other information 420 can also include a user's professional title, job description, any relevant geospatial information, and any relevant personal or other information type. The other information 420 can additionally include any other information that can be deemed relevant to the user's status. In other words, the presence document includes many different kinds of information about user state and status and, availability information 104 and activity information 106 are just two kinds of the presence document information.

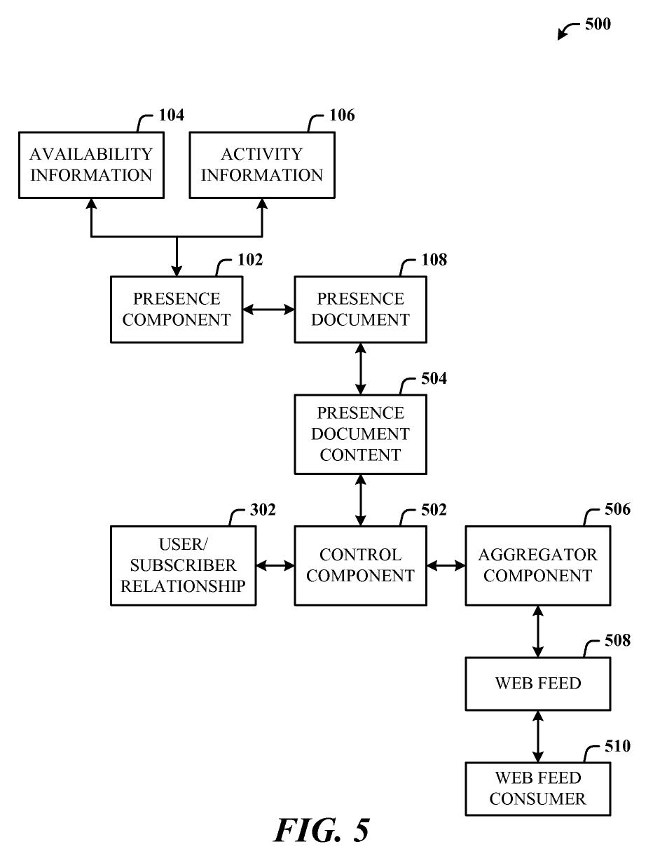

FIG. 5 illustrates an alternative embodiment of a computer-implemented system 500 for performing communications. The presence component 102 is provided for incorporating the availability information 104 and the activity information 106 of a user into the presence document 108. A control component 502 controls access to presence document content 504 based on the user/subscriber relationship 302. The availability information 104 and activity information 106 can collectively be included in the presence document content 504, which can additionally include information regarding times, locations, project information, and related information, for example, as described hereinabove.

As further illustrated in FIG. 5, an aggregator component 506 is provided for federating the presence document 108 into a web feed 508 to enable interoperable consumption by a web feed consumer 510. The aggregator component 506 can be an RSS/Atom aggregator or other syndication component. The web feed 508 can be an RSS /Atom feed or any other suitable feed that enables interoperable consumption by a web browser or other suitable web feed consumer 510. In this way, the presence document content 504 can be consumed into applications beyond internal network endpoints, and can be interoperably accessed by a subscriber running a different communications application not operable with the application of the publisher.

The presence document 108 can be obtained by a subscriber who can access the presence document 108 (via federation or other authentication). The presence document 108 includes contents readable by one or more supported protocols so that the subscriber's device can interpret the contents in one or more of the formats represented in the presence document 108. The subscriber user can either access the original presence document 108, or can view the extended, interoperable presence document, which can be compatible with the same network communications application.

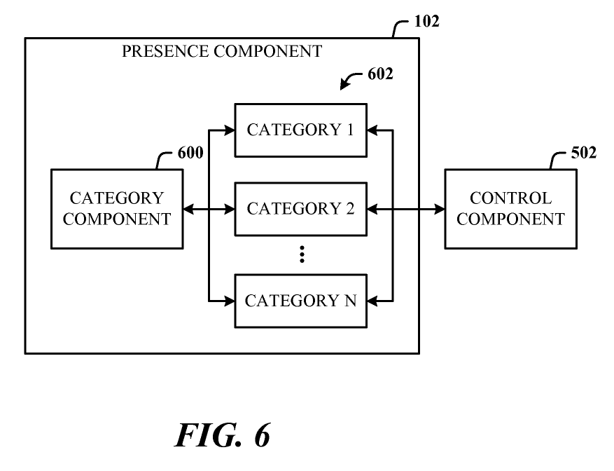

FIG. 6 illustrates additional aspects of the presence component 102. A category component 600 facilitates the specification of categories 602 of the presence document content 504. The control component 502 controls access to the presence document content 504 (e.g., the availability information 104 and the activity information 106) according to the categories 602, based on the relationship 302 between the publisher and the subscriber.

The categories 602 can include category instances corresponding to user authentication levels. In this way, security can be established to enable subscribers to access particular information according to the predefined relationships, such as an internal hierarchy within an organization. For example, a manager can have an authentication level for viewing the entire presence document content 504 for subordinates within an organization, but the subordinates are not allowed to view the entire presence document content 504. The categories 602 can include multiple syndicated channels corresponding to multiple subscriber access levels, where access to a particular channel is determined based on the user/subscriber relationship 302. The categories 602 can also be provided through filtering of a single channel.

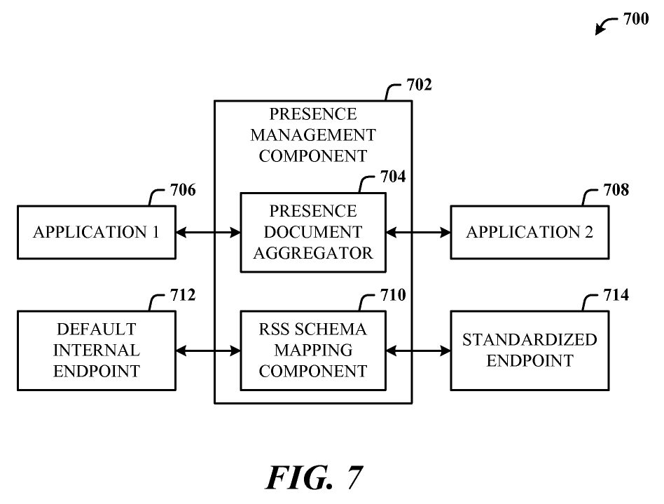

FIG. 7 illustrates an implementation 700 for aggregating and mapping presence information. A presence management component 702 can be employed for handling aggregation, distribution, and formatting of presence information, for managing communications between publishers and subscribers, and for hosting interactive components. However, it is to be appreciated that this is only an exemplary embodiment and in no way limiting of the embodiments disclosed herein. The presence management component 702 includes a presence document aggregator 704 that receives availability information and activity information from a first application 706 and a second application 708. The presence document aggregator 704 publishes the availability information and activity information into a presence document. The presence document aggregator 704 federates information across an organization as well as business and/or consumer networks with which the organization can be affiliated.

As further illustrated in FIG. 7, the presence management component 702 includes an RSS schema mapping component 710 for converting the presence document into an RSS schema, and thereby into a syndicated RSS feed. The presence management component 702 exposes the RSS feed to a web service and/or other interfaces to allow both a default internal endpoint 712 within a local network, and a standardized endpoint 714 outside the local network to consume the RSS feed. The presence management component 702 can also include services component (e.g., Active Directory™ by Microsoft Corporation) for providing network service for controlling access to both publication and subscription to the information in the presence document.

In an exemplary operation of the herein disclosed embodiments, a presence document can include multiple “containers” for each of the categories of information that are used to control access. Subscriber clients that do not provide authentication can be presented with a default container and access to categories published in that container. For example, a user of an enterprise application can publish activity information to a presence document, and can include changes in an authenticated data profile and document changes on an enterprise application site. The aggregator 704 can aggregate this information with other realtime information changes such as location, a personal note, out-of-the-office message, and phone numbers, for example. The presence document is extended to a syndicated language protocol (e.g., RSS, Atom, etc.) to enable interoperability. A subscriber can subscribe to this presence document via an RSS feed and view the feed through a web browser.

As disclosed herein, presence is handled as a service allowing enterprise applications and social media to publish user activity information in the presence document. Presence as a service is authenticated based on a common identification for a subscriber user that can be based on network services authentication for enterprise users or other authentication clients for consumer or non-network services users. An authenticated application can implement a presence service to publish information into a presence document. The presence document allows any publisher to specify categories of information and a container for access control that can be provided for a particular category of data.

As disclosed herein, applications associated with a publishing user can also publish information about source, publish data time and other information as defined by the schema of presence document. Information published by the applications and different endpoints can be sent to a communications server. Extension to presence and RSS or other syndicated protocol allows interoperability.

The following table depicts an exemplary mapping of presence document elements to corresponding RSS schema elements. It is to be appreciated that the following is simply an illustration and does not define a protocol documentation or the final schema.

| Presence Document-Elements | RSS-Elements |
|---|---|
| Categories | Channels |
| Category Instance | Channel |
| Category sub elements (Data) | Item |

Each category instance published as an RSS channel can include a publish time and source information. Further, each item published within a category instance can include its own publish time to control the granularity of information provided to a subscriber upon a change in the data. Each category instance in the presence document can be associated with a container that defines a membership status of each subscriber having access to that particular category of data. Rich access control can be further provided through an extension of the RSS protocol or other syndication protocols. In an alternative aspect, a subscriber can present identification directly to the system and request RSS data with only the category instances to which access has been granted. The system can in turn return the data in RSS format to the client requesting the data.

As disclosed herein, the embodiments enable federating of presence information to compliant, internal network endpoints and non-compliant but interoperable endpoints using a standardized format such as an RSS or Atom format, for example, or other syndicated web feed formats. By making presence information available in RSS or Atom format, any subscriber client with an authenticated identity can subscribe to the presence document. These clients can be compliant, internal network clients or non-compliant but interoperable clients operating with standardized formats, such as web browsers. The embodiments provide a federation mechanism for securely publishing presence information to trusted organizations. This will enable users in the trusted organizations to view the RSS feed of other users across the organization.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

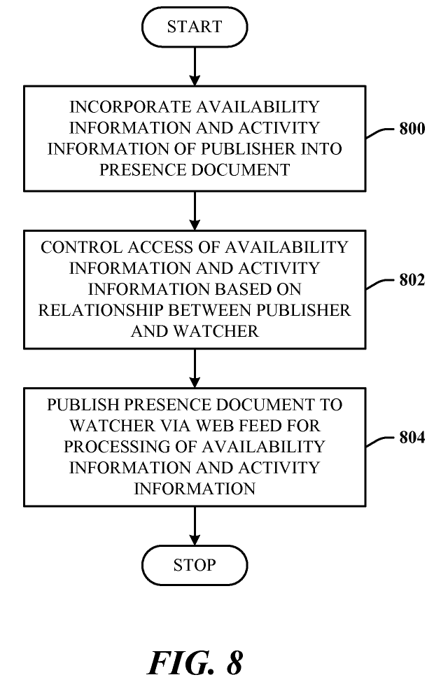

FIG. 8 illustrates a method of communications. At 800, availability information and activity information of a publisher are incorporated into a presence document. At 802, access of the availability information and the activity information is controlled based on a relationship between the publisher and a watcher. At 804, the presence document is published to the watcher via the web feed for processing of the availability information and the activity information. In this way, presence information can be made securely available to watchers using a web browser, rather than only watchers using a proprietary enterprise application on an internal local network.

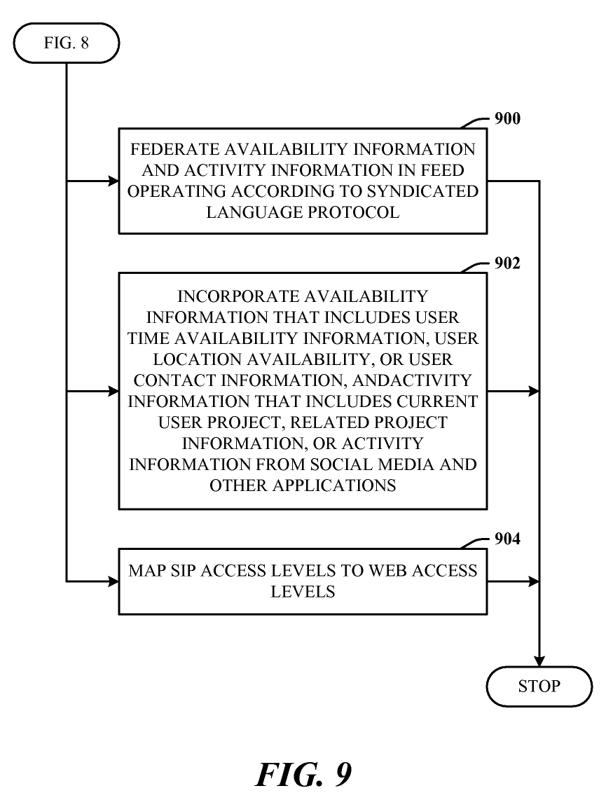

FIG. 9 illustrates further aspects in the method of communications. At 900, the availability information and the activity information are federated in a feed operating according to a syndicated language protocol. The feed can be interoperably consumed by the standard subscriber using an RSS consumer, for example. At 902, availability information is incorporated that includes user time availability information, user location availability information, or user contact information, and activity information is incorporated that includes a current user project, related project information, or activity information from social media and enterprise applications. At 904, SIP access levels are mapped to web access levels. This can be accomplished via syndicated channels, for example.

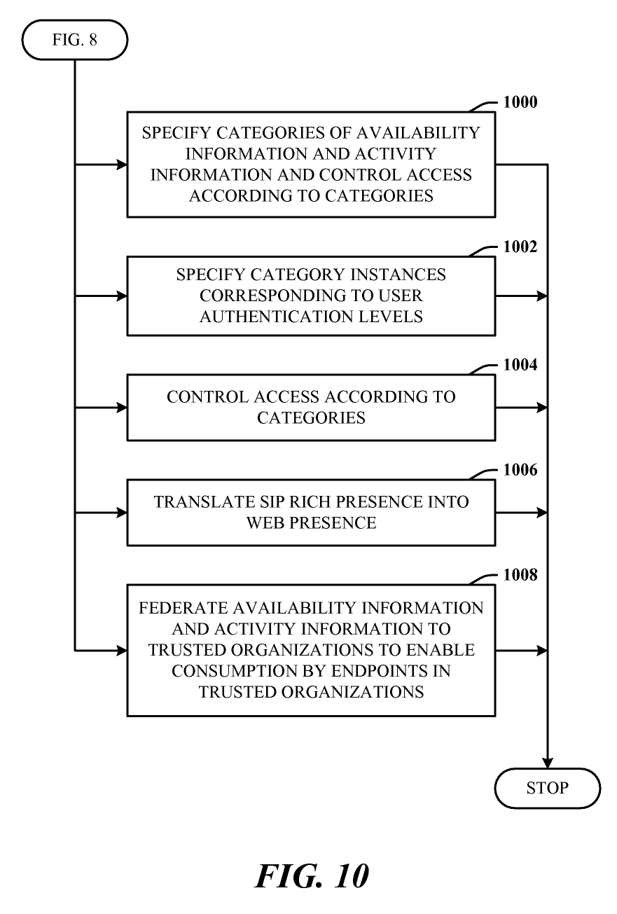

FIG. 10 illustrates additional aspects in the method of communications. At 1000, categories are specified for the availability information and activity information, and access is controlled according to the categories. At 1002, the category instances are specified corresponding to user authentication levels. At 1004, access is controlled according to the categories. At 1006, SIP rich presence can be translated into web presence. At 1008, the availability information and activity information are federated to trusted organizations to enable consumption by endpoints in the trusted organizations.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

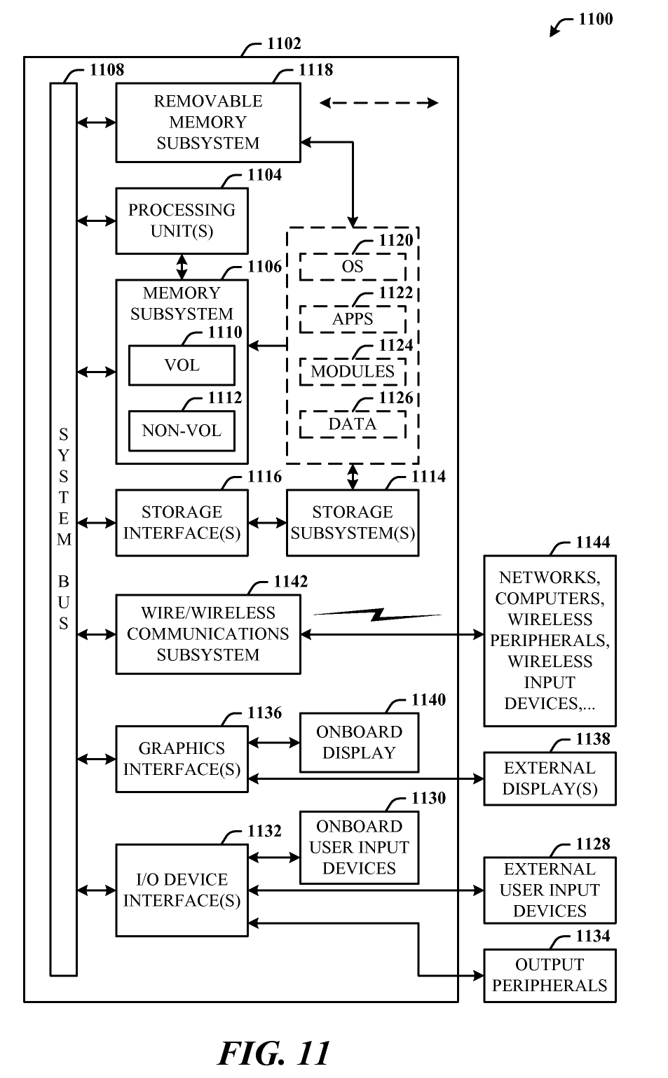

Referring now to FIG. 11, there is illustrated a block diagram of a computing system 1100 operable to execute communications in accordance with the disclosed architecture. In order to provide additional context for various aspects thereof, FIG. 11 and the following discussion are intended to provide a brief, general description of the suitable computing system 1100 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 1100 for implementing various aspects includes the computer 1102 having processing unit(s) 1104, a system memory 1106, and a system bus 1108. The processing unit(s) 1104 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 1106 can include volatile (VOL) memory 1110 (e.g., random access memory (RAM)) and non-volatile memory (NON-VOL) 1112 (e.g., ROM, EPROM, EEPROM, etc.). A basic input/output system (BIOS) can be stored in the non-volatile memory 1112, and includes the basic routines that facilitate the communication of data and signals between components within the computer 1102, such as during startup. The volatile memory 1110 can also include a high-speed RAM such as static RAM for caching data.

The system bus 1108 provides an interface for system components including, but not limited to, the memory subsystem 1106 to the processing unit(s) 1104. The system bus 1108 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 1102 further includes storage subsystem(s) 1114 and storage interface(s) 1116 for interfacing the storage subsystem(s) 1114 to the system bus 1108 and other desired computer components. The storage subsystem(s) 1114 can include one or more of a hard disk drive (HDD), a magnetic floppy disk drive (FDD), and/or optical disk storage drive (e.g., a CD-ROM drive DVD drive), for example. The storage interface(s) 1116 can include interface technologies such as EIDE, ATA, SATA, and IEEE 1394, for example.

One or more programs and data can be stored in the memory subsystem 1106, a removable memory subsystem 1118 (e.g., flash drive form factor technology), and/or the storage subsystem(s) 1114, including an operating system 1120, one or more application programs 1122, other program modules 1124, and program data 1126. Generally, programs include routines, methods, data structures, other software components, etc., that perform particular tasks or implement particular abstract data types. All or portions of the operating system 1120, applications 1122, modules 1124, and/or data 1126 can also be cached in memory such as the volatile memory 1110, for example. It is to be appreciated that the disclosed architecture can be implemented with various commercially available operating systems or combinations of operating systems (e.g., as virtual machines).

The aforementioned application programs 1122, program modules 1124, and program data 1126 can include the computer-implemented system 100, the presence component 102, the availability information 104, the activity information 106, the presence document 108, the schema component 110, the standardized schema 112, and the standardized endpoint 114 of FIG. 1, the RSS schema component 200, the RSS protocol 202, and the RSS consumer 204 of FIG. 2, the access control component 300, the user/subscriber relationship 302, and the default internal endpoint 304 of FIG. 3, the user time availability 400, the user location availability 402, the user contact information 404, the current user project 406, the related project information 408, the publish time information 412, the source information 414, the publish time information 416, and the source information 418 of FIG. 4.

The aforementioned application programs 1312, program modules 1314, and program data 1316 can also include the computer-implemented system 500, the presence component 102, the availability information 104, the activity information 106, the presence document 108, the control component 502, the presence document content 504, the user/subscriber relationship 302, the aggregator component 506, the web feed 508, and the web feed consumer 510 of FIG. 5, the category component 600 and the categories 602 of FIG. 6, the implementation 700, the communications server 702, the presence document aggregator 704, the first application 706, the second application 708, the RSS schema mapping component 710, the internal endpoint 712, and the standardized endpoint 714 of FIG. 7, and the methods of FIGS. 8-10, for example.

The storage subsystem(s) 1114 and memory subsystems (1106 and 1118) serve as computer readable media for volatile and non-volatile storage of data, data structures, computer-executable instructions, and so forth. Computer readable media can be any available media that can be accessed by the computer 1102 and includes volatile and non-volatile media, removable and non-removable media. For the computer 1102, the media accommodate the storage of data in any suitable digital format. It should be appreciated by those skilled in the art that other types of computer readable media can be employed such as zip drives, magnetic tape, flash memory cards, cartridges, and the like, for storing computer executable instructions for performing the novel methods of the disclosed architecture.

A user can interact with the computer 1102, programs, and data using external user input devices 1128 such as a keyboard and a mouse. Other external user input devices 1128 can include a microphone, an IR (infrared) remote control, a joystick, a game pad, camera recognition systems, a stylus pen, touch screen, gesture systems (e.g., eye movement, head movement, etc.), and/or the like. The user can interact with the computer 1102, programs, and data using onboard user input devices 1130 such a touchpad, microphone, keyboard, etc., where the computer 1102 is a portable computer, for example. These and other input devices are connected to the processing unit(s) 1104 through input/output (I/O) device interface(s) 1132 via the system bus 1108, but can be connected by other interfaces such as a parallel port, IEEE 1394 serial port, a game port, a USB port, an IR interface, etc. The I/O device interface(s) 1132 also facilitate the use of output peripherals 1134 such as printers, audio devices, camera devices, and so on, such as a sound card and/or onboard audio processing capability.

One or more graphics interface(s) 1136 (also commonly referred to as a graphics processing unit (GPU)) provide graphics and video signals between the computer 1102 and external display(s) 1138 (e.g., LCD, plasma) and/or onboard displays 1140 (e.g., for portable computer). The graphics interface(s) 1136 can also be manufactured as part of the computer system board.

The computer 1102 can operate in a networked environment (e.g., IP) using logical connections via a wire/wireless communications subsystem 1142 to one or more networks and/or other computers. The other computers can include workstations, servers, routers, personal computers, microprocessor-based entertainment appliance, a peer device or other common network node, and typically include many or all of the elements described relative to the computer 1102. The logical connections can include wire/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 1102 connects to the network via a wire/wireless communication subsystem 1142 (e.g., a network interface adapter, onboard transceiver subsystem, etc.) to communicate with wire/wireless networks, wire/wireless printers, wire/wireless input devices 1144, and so on. The computer 1102 can include a modem or has other means for establishing communications over the network. In a networked environment, programs and data relative to the computer 1102 can be stored in the remote memory/storage device, as is associated with a distributed system. It will be appreciated that the network connections shown are exemplary and other means of establishing a communications link between the computers can be used.

The computer 1102 is operable to communicate with wire/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

The illustrated aspects can also be practiced in distributed computing environments where certain tasks are performed by remote processing devices that are linked through a communications network. In a distributed computing environment, program modules can be located in local and/or remote storage and/or memory system.

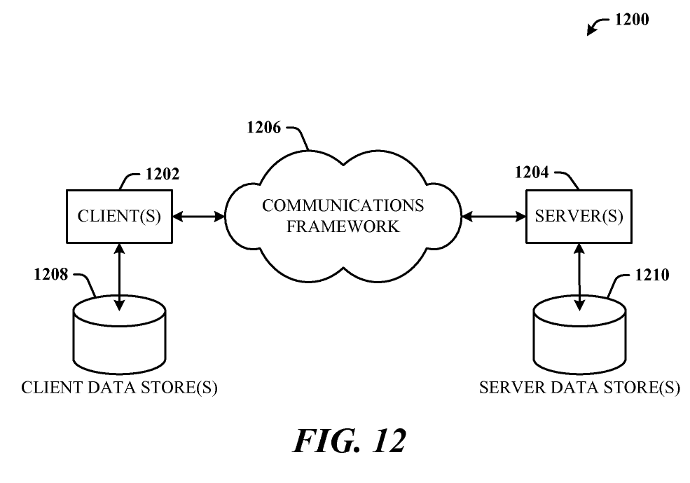

Referring now to FIG. 12, there is illustrated a schematic block diagram of a computing environment 1200 that can perform communications. The environment 1200 includes one or more client(s) 1202. The client(s) 1202 can be hardware and/or software (e.g., threads, processes, computing devices). The client(s) 1202 can house cookie(s) and/or associated contextual information, for example.

The environment 1200 also includes one or more server(s) 1204. The server(s) 1204 can also be hardware and/or software (e.g., threads, processes, computing devices). The servers 1204 can house threads to perform transformations by employing the architecture, for example. One possible communication between a client 1202 and a server 1204 can be in the form of a data packet adapted to be transmitted between two or more computer processes. The data packet may include a cookie and/or associated contextual information, for example. The environment 1200 includes a communication framework 1206 (e.g., a global communication network such as the Internet) that can be employed to facilitate communications between the client(s) 1202 and the server(s) 1204.

Communications can be facilitated via a wire (including optical fiber) and/or wireless technology. The client(s) 1202 are operatively connected to one or hmore client data store(s) 1208 that can be employed to store information local to the client(s) 1202 (e.g., cookie(s) and/or associated contextual information). Similarly, the server(s) 1204 are operatively connected to one or more server data store(s) 1210 that can be employed to store information local to the servers 1204.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented communications system, comprising:
a presence component for incorporating user information into a presence document; and
a schema component for mapping the presence document into a standardized, interoperable schema and federating to a standardized endpoint based on the schema.

2. The system of claim 1, wherein the standardized schema comprises a mapping to a web feed and the standardized endpoint is a web feed consumer.

3. The system of claim 1, wherein the schema component comprises an RSS (really simple syndication) schema component for extending the presence document according to an RSS protocol.

4. The system of claim 1, wherein the standardized endpoint comprises a web feed consumer for consuming the presence document in a syndicated language.

5. The system of claim 1, further comprising an access control component for controlling access to the user information in the presence document based on a user/subscriber relationship.

6. The system of claim 1, wherein the schema component federates the presence document to standardized and default internal endpoints.

7. The system of claim 1, wherein the user information further comprises availability information that includes at least one of user time availability information, user location availability information, or user contact information.

8. The system of claim 1, wherein the user information further comprises activity information that includes at least one of a current user project on which the user is working, related project information, or activity information from social media and enterprise applications.

9. The system of claim 1, wherein the presence document further comprises publish time information and source information for the user information.

10. A computer-implemented communications system, comprising:
a presence component for incorporating availability information and activity information of a user into a presence document;
a control component for controlling access of presence document content based on a relationship between the user and a subscriber; and
an aggregator component for federating the presence document into a web feed to enable standardized, interoperable consumption by a web feed consumer.

11. The system of claim 10, further comprising a category component for specifying categories of the presence document content, the control component controls access according to the categories.

12. The system of claim 11, wherein the categories specified by the category component include category instances that correspond to user authentication levels and multiple syndicated channels that correspond to multiple subscriber access levels.

13. The system of claim 10, further comprising a schema component for mapping the presence document into a standardized, interoperable RSS schema.

14. A computer-implemented method of communications, comprising:
incorporating availability information and activity information of a publisher in a presence document;
controlling access to the availability information and the activity information based on a relationship between the publisher and a watcher; and
publishing the presence document to the watcher via a web feed for processing of the availability information and the activity information.

15. The method of claim 14, further comprising federating the availability information and the activity information in a feed operating according to a syndicated language protocol, the feed consumed an RSS consumer of a subscriber.

16. The method of claim 14, wherein the availability information includes one or more of user time availability information, user location availability information, or user contact information, and the activity information includes one or more of a current user project, related project information, or activity information from social media and enterprise applications.

17. The method of claim 14, further comprising mapping SIP (session initiation protocol) access levels to web access levels.

18. The method of claim 14, further comprising:
specifying categories of the availability information and activity information;
specifying category instances corresponding to user authentication levels; and
controlling access according to the categories.

19. The method of claim 14, further comprising translating SIP rich presence into web presence.

20. The method of claim 14, further comprising federating the availability information and activity information to trusted organizations for consumption by endpoints in the trusted organizations.
